(19) United States
(12) Patent Application Publication
(10) Pub. No.: US 2022/0036744 A1
(43) Pub. Date: Feb. 3, 2022

(54) System to automate a non-destructive test for stress or stress change using unmanned aerial vehicle and ultrasound

(71) Applicant: Yoshikazu Yokotani, Regensburg (DE)

(72) Inventor: Yoshikazu Yokotani, Regensburg (DE)

(21) Appl. No.: 16/945,873

(22) Filed: Aug. 2, 2020

(51) Int. Cl. G08G 5/00; G01N 29/07; G01N 29/22; G01S 13/08; G01S 13/933; G01N 29/24; G01N 29/265; G01K 13/00; G05D 1/10; B64C 39/02; B64D 17/80

(52) U.S. Cl. CPC G08G 5/0039; B64C 2201/141; G01N 29/225; G01S 13/08; G01S 13/933; G01N 29/24; G01N 29/265; G01K 13/00; G08G 5/0069; G05D 1/104; G08G 5/0082; B64C 39/024; B64D 17/80; G01N 2291/011; G01N 2291/0234; G01N 2291/044; G01N 2291/101; G01N 2291/106; B64C 2201/027; B64C 2201/108; B64C 2201/12; G01N 29/07

(57) ABSTRACT

This invention discloses a system to automate a non-destructive test (NDT) for measuring stress or stress change developed within an object during a certain time period by using unmanned aerial vehicles (UAV) and ultrasound technique. The system comprises a ground control station (GCS), UAVs and reference positioning modules as its basis. Given a test plan containing test points over a surface of a test object in 3D point coordinates, UAVs can fly autonomously to the points and perform ultrasound measurements on them with a single or a plurality of ultrasound transducers in an automated manner. Moreover, after receiving trigger signals from the GCS, a UAV can also perform the flight and the measurement synchronously with other UAVs. After a measurement, an acquired ultrasound echo signal is taken with another echo signal acquired at a different time point to compute stress or stress change.

### REFERENCE CITED

### U.S. Patent Documents

U.S. Pat. No. 7,752,913 B2 July 2010 Heckel et al.
10252800 B1 April 2019 Dorsey
10620002 B2 April 2020 Al-Jabr
0236285 A1 October 2008 McInerney et al.
10247705 B2 April 2019 Pellegrino et al.
U.S. Pat. No. 8,371,173 B1 February 2013 DiMambro et al.
U.S. Pat. No. 8,280,648 B2 October 2012 Larose et al.

### OTHER PUBLICATIONS

L. Cartz, “Nondestructive Testing”, ASM International, 1995, ISBN 978-0-87170-517-4.
Krautkraemer, “Nondestructive Material Testing with Ultrasonics—Introduction to the Basic Principles”, https://www.ndt.net/.
Y. Bar-Cohen, “Biologically Inspired Robots as Artificial Inspectors—Science Fiction and Engineering Reality”, 16th World Conference on NDT 2004.
E. Cuevas et al., “Ultrasonic Techniques and Industrial Robots: Natural Evolution of Inspection Systems”, 4th Int. Symposium on NDT in Aerospace, 2012.
W. C. Myeong, et al., “Drone-Type Wall-Climbing Robot Platform for Structural Health Monitoring”, 6th International Conference on Advances in Experimental Structural Engineering, 2015.
R. Mattar, “Development of a Wall Sticking Drone for Non-Destructive Ultrasonic and Corrosion Testing”, Inspectioneering, https://inspectioneering.com/journal/2018-04-25/7567/development-of-a-wall-sticking-drone-for-non-destructive-ultraso.
S. Hubei et al., “Basic Investigations to Establish an Ultrasonic Stress Evaluation Technique for Aero Engine Materials”, 4th International Symposium on NDT in Aerospace 2012.
H. Walaszek et al., “Application of ultrasonic measurements to stress assessment on already tightened bolts”, European Conference on Non-destructive Testing 2014.
R. Scneider, “The Theory of Coda Wave Interferometry”, Pure appl. Geophys. 163 (2006) 455-473, 2006.
Y. Zhang et al., “Study of stress-induced velocity variation in concrete under direct tensile force and monitoring of the damage level by using thermally-compensated Coda Wave Interferometry”, Ultrasonics, 52(8), pp 1038-1045, 2012.
E. Niederleithinger et al., “Processing Ultrasonic Data by Coda Wave Interferometry to Monitor Load Tests of Concrete Beams”, Sensors 2018.
S. C. Staehler et al., “Monitoring stress changes in a concrete bridge with coda wave interferometry”, J. Acoust. Soc. Am. 129(4), April 2011.
C. Pacheco et al., “Time-lapse travel time change of multiply scattered acoustic waves”, J. Acoust. Soc. Am. 118 (3), 1300-1310, 2005.
E. Larose et al., “Locating a small change in a multiple scattering environment”, Applied Physics Letter 96, 204101, 2010.
Marvelmind Robitics, https://marvelmind.com/.
R. B. Langley, “RTK GPS”, GPS World 70-76, September 1998.
MAVLink Developer Guide, https://mavlink.io/en/.
R. Murayama, “Development of Ultrasonic Wave Nondestructive Inspection Robot Without Coupling Medium Using EMAT”, 16th World Conference on NDT 2004.
E. Niederleithinger et al., “Influence of Small Temperature Variations on the Ultrasonic Velocity in Concrete”, the 39th Annual Review of Progress in Quantitative Nondestructive Evaluation AIP Conf. Proc. 1511, pp. 390-397, Vol. 31, 2012.
E. Brunner, “How Ultrasound System Considerations Influence Front-End Component Choice”, vol. 36, Analog Dialogue May 2002.

### STATEMENT REGARDING PRIOR DISCLOSURE BY THE INVENTOR

None

### TECHNICAL FIELD

The invention is related to a system for automating a non-destructive test for objects using unmanned aerial vehicles and ultrasound technique.

### BACKGROUND

Non-destructive test (NDT) has been an important method to test a structural health condition of an object without its destruction by using techniques such as ultrasound. An NDT is normally carried out as a form of manual test. However, when a resource for carrying out an NDT is limited, an approach to automate it would be desirable.

In the last decades, attempts to automate an NDT by using a robot have been reported. This may make it possible to mitigate an above-mentioned issue. Nonetheless, when a test area contains places which are difficult for a robot to reach, a robot needs to be brought there. Also, if a coverage of an NDT ranges among a plurality of surfaces of a test object, a robot might have to move from one surface to another. Therefore, for such cases, use of an unmanned aerial vehicle (UAV) may be a possibility, since a UAV can autonomously fly to a test surface, function as an NDT device there and again autonomously fly to the next test surface.

U.S. patent Ser. No. 10/252,800 discloses a UAV-based ultrasound NDT method. In this method, an associated NDT scanner is taken by a drone to a place, which is difficult for a person to reach. Before and after a test, the scanner is deployed and retrieved by a drone, respectively. In addition, during a test, a deployed scanner moves independently of the vehicle. However, because of its deployment and retrieval mechanism, the entire system could become complex. Moreover, in order to test multiple surfaces, a UAV might need to repeat these two steps of deployment and retrieval.

In this invention, a UAV integrates a single or a plurality of ultrasound transducers, and, hence, there is no necessity of having a mechanism for deployment and retrieval. In addition, by employing an autopilot software program and also making this program call an ultrasound measurement functionality, a UAV can autonomously fly onto a test object and subsequently carry out an ultrasound measurement. This way, we can automate an NDT, and this could be done in a less complicated way than the method described by the U.S. patent Ser. No. 10/252,800, where the scanner might need its own automated mechanism and such a mechanism has to be synchronized with the UAV's deployment and retrieval mechanism.

Mattar and U.S. patent Ser. No. 10/620,002 disclose a UAV for a wall thickness inspection. In their approaches, an electromagnetic material or a proximity sensor is used to control a contact or a near contact with a wall, respectively. These approaches have aimed for an autonomous inspection, however, they may be seen as a form of point-wise measurements, but not a systematic execution of measurements to aim for completing an NDT on an entire test object, except for parts which are not in a test coverage. In our approach, we carry out an NDT on an entire test object with such an exception. To do this, we may use a set of 3D point cloud measured over surfaces of a test object as waypoints. Therefore, we can basically rely on the same waypoint navigation algorithm for both a navigation from a launching or landing zone to a test object and a navigation between two test points. On the other hand, the method described by U.S. patent Ser. No. 10/620,002 might use a different position control approach with the proximity sensor from its default waypoint navigation algorithm. Because of this reason, our approach might be simpler. Moreover, in our invention, in order to measure stress or stress change developed within a test object, we might have to deploy a plurality of UAVs to measure at a plurality of point as ultrasound transmitters and receivers. To ensure an accurate measurement, a synchronized ultrasound transmission and reception of those UAVs is necessary, and therefore, a ground control station might have to moderate their synchronous measurement. Since we carry out an NDT on a plurality of test points, even a flight of each UAV from a test point to another test point might have to be moderated by the ground control station. Extension to a use of a plurality of UAVs and the involvement of a ground control station for synchronous flights and measurements is another different point from conventional methods.

### BRIEF SUMMARY OF INVENTION

In this invention, a system to automate a non-destructive test (NDT) for measuring stress or stress change developed during a certain time period within an object by using a single or a plurality of unmanned aerial vehicles (UAV) and ultrasound technique is disclosed.

In this system, a single or a plurality of UAVs are given a flight plan. An autopilot flight command in a flight plan will be executed, so that a UAV can autonomously fly to a test point located on a surface of a test object. A flight plan also contains an action command. When a UAV reaches a test point, it executes this command to carry out an ultrasound measurement on the point. By concatenating and repeating a pair of a flight and a measurement, a UAV can fly to and measure at test points covering a test object. Hence, automating an NDT on a test object may be possible. For a plurality of UAVs to carry out an automated NDT, a synchronized operation among those UAVs may be considered. For this, we may create a flight plan for each UAV, so that each UAV flies to a test point and wait there until a trigger from a ground control station arrives, and, then performs a measurement on the point simultaneously with other UAVs. A flight plan also contains information about a role of each UAV as either a transmitter or a receiver and about whether each UAV is active or inactive during a measurement. A role of a transmitter indicates that a transmitter UAV emits an electrical pulse signal on an ultrasound transducer contacted or nearly contacted on a surface. On the other hand, a receiver UAV receives an echo signal from a surface through the transducer. Note that, a UAV makes a near contact, when it uses an electromagnetic acoustic transducer (EMAT) on a metallic test object.

An NDT in this invention is for measuring stress or stress change developed during a certain time period within a test object. This stress measurement is based on an acoustoelastic effect of a tested material, where a stress-induced acoustic velocity variation is proportional to the stress level, when the material may be assumed to be isotropic. By using two ultrasound echo signal waveforms acquired at the beginning and the end of a certain time period, we may compute an ultrasound velocity change. Depending on the homogeneity or heterogeneity of a test object, we can use either time-of-flight (TOF) or coda wave interferometry (CWI) method. TOF method is used to measure a velocity change of the direct ultrasound wave, arriving first at a measurement point, and may be used for homogeneous materials or materials under large stress. On the other hand, CWI method is for measuring a velocity change of late arriving coda waves, and this method is useful for heterogeneous materials due to its high sensitivity. To visualize a stress distribution developed within a test object, we use a form of stress map. A stress map depicts a stress distribution over a test surface two-dimensionally obtained by methods such as above-mentioned ones. For creating such a map, it is natural to collect a plurality of measurement outcomes. Unlike conventional methods, where positions of ultrasound transducers are fixed, this invention may change test positions and the numbers flexibly by changing a flight plan. This is beneficial, especially when the initial stress is unknown.

### BRIEF DESCRIPTION OF THE DRAWINGS

FIG. 1 shows a realization of a UAV-based automated NDT system, where a UAV is testing a surface of an object to measure stress or stress change.

FIG. 2 shows a conceptual illustration of a UAV having ultrasound transducers for a non-destructive test.

FIG. 3 shows a modified version of FIG. 2 having a vertically installed propeller on another end of the transducers.

FIG. 4 shows a conceptual illustration of a tri-copter based UAV having ultrasound transducers for a non-destructive test.

FIG. 5 shows a system block diagram.

FIG. 6 shows a process flow diagram for a UAV to individually perform a contact or a near contact with a test surface, an ultrasound measurement and a flight to the next point.

FIG. 7 shows a process flow diagram for a UAV, with other UAVs, to collaboratively perform a contact or a near contact with a test surface, an ultrasound measurement and a flight to the next point.

FIG. 8 shows a plurality of UAVs carrying out measurements on sectioned test surfaces.

FIG. 9 shows a UAV, testing a ceiling of a test object.

FIG. 10 shows a UAV, testing a floor of a test object or a test place.

FIG. 11 shows a triangle-waveform movement of a UAV to fly through test points T₀, T₁, T₂, . . . on a test surface via hold points H₀, H₁, H₂, . . . . These points indicate positions of ultrasound transducers. The UAV itself is not shown in this figure.

FIG. 12 shows another illustration of flight movements of ultrasound transducers similar to FIG. 11, but this case has a sawtooth-waveform movement.

FIG. 13 shows a UAV loitering with ultrasound transducers at the hold point H₀. The UAV changes its pitch angle to Th_{PHO} and becomes ready to move to the test point T₀.

FIG. 14 shows a plurality of UAVs measuring stress or stress change sensed over a surface, where the vehicles function as ultrasound transmitters at points T and those travelling along the path R function as their reception counterparts.

### DETAILED DESCRIPTION

This invention stands on a system, and its basis comprises 1) a ground control station (GCS), 2) a single or a plurality of UAVs and 3) a single or a plurality of reference positioning modules. The GCS monitors and controls a flight of a UAV. At the same time, a single or a plurality of reference positioning modules transmit data for a UAV to determine its position. Within a UAV, it comprises a flight controller and an ultrasound measurement module. The flight controller is responsible for realizing its autonomous flight to fly around and contact or nearly contact a test object, and if necessary, it may also compute a stress map from ultrasound echo signals. The ultrasound measurement module carries out an ultrasound measurement to acquire an ultrasound echo signal. This measurement is triggered by the flight controller, and, as its response, the module sends back a completion notice to the flight controller. In details, we will describe these three points 1)-3) below. It is also mention here that, an expression “and/or” in the following descriptions means either “and” or “or”.

Firstly, we describe a GCS. Hardware-wise, it can be a PC, a laptop computer or a tablet. By working under a GCS, a user can create a flight plan, let a UAV fly according to the plan, and monitor its flight state in the real time. A flight plan may contain a sequence of autopilot flight commands, ultrasound measurement control commands and their parameters. In our case, we make a flight plan, given a precomputed 3D surface point cloud measured over surfaces of a test object. Except for part of surfaces and/or part of a test object, an NDT with such a plan could cover an entire test object. In addition, a flight plan may treat flights between a launching or landing zone and a test object and flights between test points in the same way. This is a difference from approaches described by Mattar and U.S. patent Ser. No. 10/620,002. Mattar discloses an approach to fly to a test object by means of a remote manual control or a partial automation. Here, it is mentioned that, to avoid large obstacles, our approach may also choose a remote manual control at the beginning of a test on a test object and the following test would proceed fully automatically according to a flight plan. Alternatively, a space which is openly connected to a test object may be chosen as a launching or landing zone. U.S. patent Ser. No. 10/620,002 uses a method to get close to a test surface may be a part of a wall thickness measurement, and its position control may be treated differently from the rest of its flight control mechanism. Since a flight plan configures not only a flight but also an ultrasound measurement in our case, we will call a flight plan as a test plan in the following description.

Contents of a test plan are the followings: 1) autopilot flight command, 2) test and hold point coordinates, 3) attitude (roll, pitch and yaw), 4) ultrasound measurement control command, 5) angle of the rod holding ultrasound transducers, 6) operation mode of the transducers and 7) other relevant parameters.

An autopilot flight command may be the one defined by the MAVLink protocol. For a flight plan, MAVLink defines three different command types—NAV command, DO command and CONDITION command. NAV command is for navigating a UAV. DO command is for taking an action during the flight. CONDITION command is for a condition-based execution of a task. To make a test plan, we use NAV commands and DO commands and add WAIT command as a new one. NAV command is for navigating a UAV to hold points and test. DO command is for carrying out a single or a plurality of ultrasound measurements on test points. WAIT command is for a UAV to wait for a trigger from a GCS to carry out a synchronized flight or measurement operation with other UAVs.

A test point means a point on a surface of a test object, and this is where a UAV carries out a single or a plurality of ultrasound measurements. A hold point means a point above a test point, and this is where a UAV prepares for a contact or a near contact on a test point. These two types of points actually indicate positions of ultrasound transducers of a UAV, but not those of the main body frame. On a hold point, this is where a UAV may change its attitude and, if necessary, the rod angle according to the angle of the surface. This is also where distance sensors facing a test surface output values within a designed valid range. In addition, control parameters tuned for a contact or a near contact will be set up for the flight control algorithm at the point. These changes and a flight control with the distance sensors are important for a UAV to smoothly contact or nearly contact the surface. In addition, as it will be described later, a vertically installed propeller will also help maintain its contact. After a contact or a near contact, an ultrasound measurement control command will be processed subsequently. Regarding both ultrasound measurement control command and the ultrasound transducer holding rod, we will describe it later, since they are more closely related to a UAV. An operation mode is used to configure each transducer as a transmitter or a receiver at each measurement. Also, this mode defines whether a transducer should be active or inactive during a measurement. We sequentially concatenate this procedure for all the test and hold points around a surface of a test object. This way, one can see such an NDT as an automated batch process. In other words, by doing so, a UAV repeats the following steps until the end of an NDT: flying to a hold point, making itself ready for a measurement by changing its attitude and the rod angle at the point, moving onto a test point and performing ultrasound measurements there. In reality, this continuous process would have to be paused when a UAV needs to leave the test object, due to a necessity of charging a battery, for example. Also, it is necessary to mention that all the test points may not cover an entire test object, when a tester decides to exclude areas which, for example, he or she thinks are inappropriate or unnecessary to test for certain reasons.

A GCS will need to play an additional role, when we apply a method such as the CWI method, where a plurality of ultrasound echo receiver UAVs might be involved. For such a case, a test plan should be made, so that those UAVs will be at specific test points at a specific time point for a synchronous measurement. This is also true for a plurality of ultrasound transmitter UAVs. Since there may be no direct communication link among UAVs in this system, each UAV only knows its own flight state and measurement timings. However, we may utilize the fact that the flight state of all the UAVs is known to a GCS. By monitoring the state, a GCS may be able to determine if each UAV has reached a test point or not. When it acknowledges that all of them have reached their destined test points, it may send a measurement trigger to them for starting a measurement. Note that, each UAV waits for the trigger by executing a WAIT command after an arrival. Once a measurement is done, it will be also known to the GCS as a part of the flight state. Subsequently, a GCS may also send a flight trigger to those UAVs in order for them to fly to the next hold point. This way, a GCS can moderate synchronous operations for both flights and measurements.

Furthermore, when a test plan starts to carry out an NDT with a plurality of UAVs, a GCS will need to organise a collaborative behaviour of the UAVs. In details, a GCS needs to set up a test plan for each UAV performing an NDT on a different test area. Moreover, a UAV may be assigned at a different time slot. This also includes a case where a UAV needs to hold its task to recharge the battery. For such a case, its neighbour or a reserved UAV might take over the task in order to maintain a continuity of an NDT.

As another remaining functionality of GCS is to compute a stress map from received ultrasound echo signals. A stress map two-dimensionally visualizes a distribution of stress or stress change developed within a test object. Stress or stress change will be computed by the GCS using a method such as the time-of-flight (TOF) method or the coda wave interferometry (CWI) method. These methods will be described within a description for UAVs later. Note here that, depending on a test objective, a stress map may be generated in 3D. In this invention, when we deploy only a single UAV, we may also perform this generation within the UAV.

Secondly, we will now describe a UAV. In this invention, a UAV comprises a body frame, a flight controller, motors, propellers, electronic speed controllers, an ultrasound beacon or an RTK receiver, a radio telemetry, batteries, distance sensors, a manually or electronically angle-controllable rod with ultrasound transducers, thermometer and camera, ultrasound measurement module, parachute, and so on. We will describe some of these components in details.

A flight controller is important hardware to control the flight of a UAV manually or autonomously. For manual control, a user normally uses a remote-controller to regulate its flight over a radio channel. On the other hand, for an autonomous flight, a user sends a flight plan (in our case, test plan) to a UAV, and a flight controller in the UAV executes the plan, when it is under auto mode.

A flight control of a UAV covers different flight scenarios such as a flight between its launching or landing zone and a test object and a flight between a hold point and a test point. These scenarios may be handled differently, since flight controls for destination points in the air and on a solid object could be different in order to avoid a collision into an object. In order to make things simple by utilising the same flight control mechanism for both scenarios, we may prepare for different control parameters tuned for a contact or a near contact with an object and set up these parameters before its flight onto a test point.

Apart from the flight control, another important task of a flight controller is to control an ultrasound measurement and handle its outcome. Since a commercial flight controller normally concentrates itself on the flight control task, in our case, it would need an additional processor for this. Controlling an ultrasound measurement is actually to send a control signal containing configuration information for a measurement to the ultrasound measurement module. This configuration information contains parameters to generate an ultrasound pulse waveform. We have two use cases for this control. First use case is for UAVs carrying out measurements alone. In this case, when a flight controller executes an ultrasound measurement control command written in a test plan, it sends a control signal to the ultrasound measurement module. Second use case is for those collaborating measurements together. In this case, a GCS sends a measurement trigger to a flight controller of all the involved UAVs. Once the flight controller of a UAV receives the trigger, it executes a halted ultrasound measurement control command and sends a control signal to the ultrasound measurement module. Note that, before the flight controller receives the trigger, these UAVs should be in a waiting state by executing a WAIT command to wait for a trigger from a GCS. After a test is or a given number of measurements are completed, each UAV will handle the outcomes—either simply transmit them to a GCS or further process them on its own to visualize the outcomes as a stress map before its transmission.

Distance sensors used in a UAV are usually for avoiding an obstacle in this invention. However, for the sensors facing a test surface, the outputs will be also used to control the flight of a UAV in order for its ultrasound transducers to contact or nearly contact a test surface. In an open-air space, these sensors would output invalid values. However, their output becomes valid when a UAV faces either an obstacle or a test surface. Under these conditions, we incorporate these distance sensors into the flight control of a UAV. Apart from its navigation between a launching or landing zone and a test object, its flight control algorithm may handle both the contact or near contact and obstacle avoidance. Since the distance for an obstacle avoidance may normally be longer than the distance between a test and a hold point, we may disable and enable the obstacle avoidance according to its position from an object. For example, when a UAV is on the way to a hold point and it crosses an obstacle avoidance distance boundary, the avoidance may be disabled. Conversely, when a UAV flies away from a test point to the next hold point, which is further than an obstacle avoidance distance boundary, the avoidance may be enabled. When a UAV is testing a wall, two distance sensors installed at the two ends of its body frame facing the wall may be used. The install direction of the sensors would have to be set upright and downward, similar to the angle of the rod, when a UAV tests a ceiling and a floor, respectively. Moreover, a single distance sensor may also be possibly installed on the rod, so that we do not have to change angles of distance sensors additionally.

As described earlier, in our case, a UAV integrates a single or a plurality of ultrasound transducers. In a hardware point of view, they are held by a UAV with a manually or electronically angle-controllable rod. The angle can be changed from −90 degrees to 90 degrees. −90 degrees indicate the rod directing at the ground, while 90 degrees mean an upright direction. Changing the angle may be able to be done either manually by hand or electronically by a flight controller. The purpose of this rod is to make an NDT possible for surfaces such as ceilings or floors of an object. We may also have a camera and a thermometer on the rod.

In this invention, a UAV may have a different type of ultrasound transducers. For example, when a test object has a metallic surface, a UAV may use an electromagnetic acoustic transducer (EMAT). With EMAT, a UAV does not need to make a contact with a surface, and hence a test point for this case is above the surface. This is a case where a UAV makes a near contact.

Regarding propellers of a UAV, we use normally four propellers, but, as another embodiment, we may have the number different from four. Also, we may use an additional propeller and its drive to hold a contact of a UAV on a test object. This propeller may be assembled vertically to the frame body of a UAV and located on another side of the rod. When a UAV flies to a test point, this propeller may help its movement and its contact during the measurements on a test point.

An ultrasound measurement module is a hardware component to conduct an ultrasound measurement. A measurement means an acquisition of ultrasound echo signal. This module comprises an ultrasound pulse generator, a transmission and reception switch and analog frontend. Given a measurement control command, the module controls the generator to generate a single or a plurality of analog electrical pulse signals. These pulse signals pass through the switch to reach ultrasound transducers. Resulting echo signals pass through the switch again, and they are sent to the analog frontend. This switch is not necessary, unless the transducers are used as both transmitters and receivers. Within the frontend, the signals may be amplified, filtered and digitally sampled through an analog-digital converter. The output will be transmitted back to the flight controller.

As we already mentioned, a purpose of this invention is to measure stress or stress change developed during a certain time period within a test object. The measurement is based on an acoustoelastic effect of a tested material, where a stress-induced acoustic velocity variation is proportional to the stress level, when the material is assumed to be isotropic. Hubel et al. and Walaszek et al. applied a Time-Of-Flight (TOF) method to measure stress on a metal object. TOF method is a way to measure a velocity of a direct ultrasound wave, which arrives at a destination first. The relative velocity variation for these two cases is computed by comparing two velocities measured under both no stress and stress. On the other hand, for heterogeneous materials such as concrete, Zhang et al. and Niederleithinger et al. applied the coda wave interferometry (CWI) method due to a high degree of scattering within the material and a resulting high sensitivity of diffused coda waves on a velocity variation. A relative velocity change can be computed by this method using the following cross correlation formula on a late arriving coda wave s(t):

$$CC ( α ) = \frac{{\int }_{t - T}^{t + T} {s}_{b} ( {t}^{′} ( 1 + α ) ) {s}_{a} ( {t}^{′} ) {dt}^{′}}{\sqrt{{\int }_{t - T}^{t + T} {s}_{b}^{2} ( {t}^{′} ( 1 + α ) ) {dt}^{′} {\int }_{t - T}^{t + T} {s}_{a}^{2} ( {t}^{′} ) {dt}^{′}}}$$

where α is a travel time perturbation stretching factor between coda wave sₐ(t) and s_{b}(t). sₐ(t) is a reference coda wave, which may be measured under no stress or at an earlier time point. s_{b}(t) is a coda wave to test, which may be measured under stress or at a later time point. T is a time window constant. According to the description by Schneider, a relative velocity change

$$\frac{δ v}{v}$$

can be obtained by αₘₐₓ,

$$\frac{δ v}{v} = \frac{- {α}_{max} t}{t} = - {α}_{max}$$

where αₘₐₓ is α which maximizes the cross correlation CC(α).

Zhang et al. have used a coda signal under no stress as its reference, whereas the reference in the method described by Niederleitthinger et al. was a coda signal measured at the beginning of a real time monitoring. In this invention, we use two ultrasound echo signals taken at different time points with either TOF or CWI method. Note that, if we measure a velocity under no stress and use it as a reference, the outcome is stress, whereas, if we measure it under a certain stress for a reference, the outcome will be stress change which developed between these two different time points. By measuring at a plurality of test points and visualizing the outcomes through interpolations, we can obtain a stress map. For example, for the CWI method, Pacheco et al. and Larose et al. employed a sensitivity kernel to develop a numerical model to interpolate the measurement points in order to create a stress map covering a test surface. Unlike a setup in these methods, where positions of ultrasound sensors are fixed, this invention can flexibly change its test positions according to a stress-dynamics within a test object. Moreover, the number of positions and the measurement frequency can be also flexibly changed in this invention. It may also be necessary to mention here that, as described by Schneider, this CWI method measures a variation of velocities of P and S waves together. Hence, because of S wave, the measured stress or stress change does not only indicate a stress over the surface, but it also means stress within the material.

The above-mentioned computation to obtain stress or stress change takes place, in this invention, in either GCS or UAV For both cases, after a test, either GCS or UAV stores a set of ultrasound echo signals as reference in a storage associated with its hardware or external hardware. Then, after the next test, either GCS or UAV may also store echo signals as test data and do the computation by using both reference and test data. For this, it is necessary to mention that the reference signal data have to be loaded to GCS or UAV prior to the computation. Moreover, as another embodiment, an external processor outside of this system may do so, instead. For a purpose of structural health monitoring, stress or stress change may be computed with data acquired at any two time points and stored in a database.

A thermometer may be used for a UAV to compensate a temperature offset on the ultrasound velocity, especially when it carries out a CWI test. Niederleithinger et al. have reported a temperature effect on the velocity intended for use of the CWI method.

A UAV may possess a parachute to avoid a crash when it goes into an emergency situation such as an electrical error of a motor. Moreover, when a UAV collides with another UAV, this countermeasure would be also needed.

Thirdly, the reference positioning module will be described. For our system, it would be either an ultrasound stationary beacon or an RTK base station. An indoor positioning system using ultrasound beacons provides a centi-meter level accuracy, for example, a product from Marvelmind Robotics. As an indoor application for this invention, a UAV can be used to perform an NDT on surfaces such as ceilings and walls. On the other hand, for an outdoor application, RTK may be used to provide also a centi-meter level accuracy. This method employs the carrier signal phase of the GPS. It tracks the fractional phase after the initial ambiguity resolution. For both cases, the number of reference positioning modules depend on the size of the test area or the test object.

An intended use for this invention may be a stress monitoring on a concrete bridge. Unlike the method described by S. C. Stähler et al., our invention can enable a tester to monitor a bridge with various configurations on positions and numbers according to a development of stress.

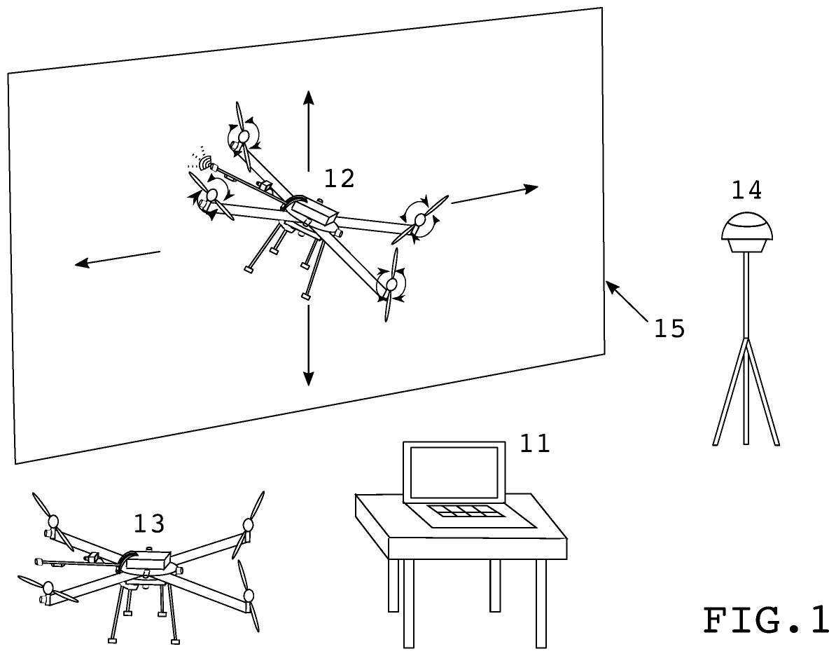

FIG. 1 shows a realization of a UAV-based automated NDT system, where the UAV 12 is testing the surface 15 of an object. The GCS 11 communicates with the UAV 12, where the GCS 11 sends a test plan to the UAV 12, whereas the UAV 12 sends its flight state and a result of ultrasound measurements to the GCS 11. The GCS 11 may comprise a PC, a laptop or a tablet and has mission planning software installed. By using this software, a tester may create, read and modify a test plan as well as monitor the flight state of a UAV. Based on the test plan, the UAV 12 moves in a given direction to test the surface 15. At the same time, reference positioning module 14 sends data to the UAV 12 to correct its GPS position in an outdoor environment. In an indoor environment, it transmits a positioning signal to determine a relative location of the UAV 12. The UAV 13 is a reserved UAV

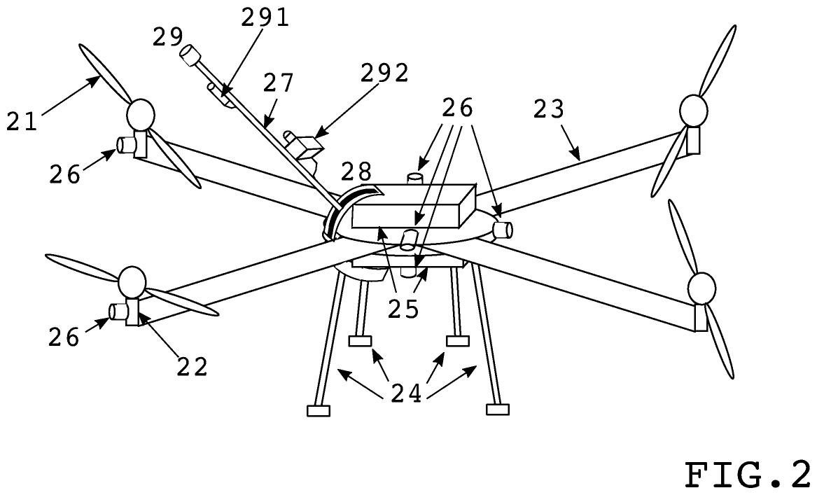

FIG. 2 shows a conceptional embodiment of a UAV. This figure illustrates a case for a quad copter. Accordingly, there are four propellers 21 and motors 22 in this figure. They are mounted on the frame 23. 24 indicates landing gears. The boxes 25 indicate a conceptual aggregation of components such as a flight controller, electronic speed controllers (ESC), a radio telemetry, an RTK receiver for outdoor environments (or an ultrasound beacon for indoor environments), a parachute, batteries, an ultrasound measurement module and other relevant components. 26 indicates distance sensors used usually for the purpose of obstacle avoidances, but they are also used for contacting or nearly contacting a test surface. 27 and 28 show a manually or electronically angle-controllable rod. Angle of the rod may be changed from −90 degrees to +90 degrees by the flight controller in order to make the angle perpendicular to a test surface. −90 degrees indicate the direction to the ground, whereas +90 degrees mean an upright direction. The angle may be computed based on 3D point coordinates forming a test surface. If necessary, the attitude may be also changed for this purpose. On the head of the rod, a single or a plurality of ultrasound transducers 29 are installed. The transducers may be also an EMAT. Thermometer 291 and camera 292 may also be used to measure a temperature of a test surface without contact and to capture an image of a test surface. All these components may be assembled at different positions and/or have different shapes, based on a use case.

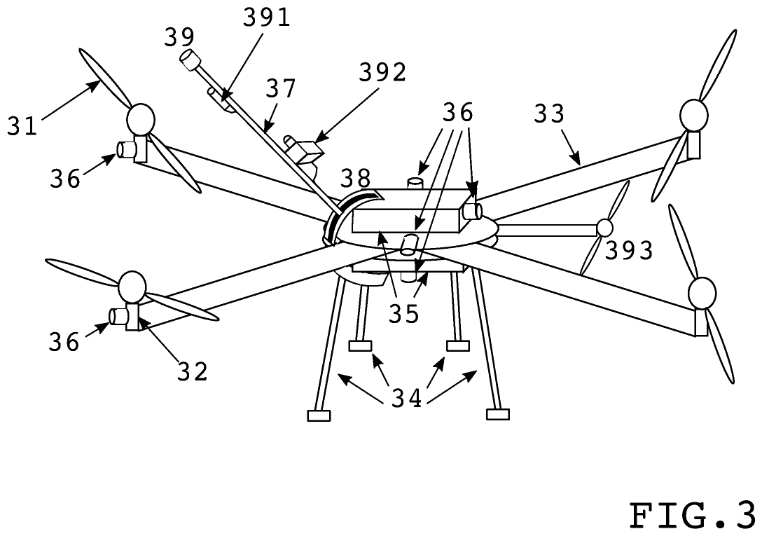

FIG. 3 shows also a conceptual embodiment of a UAV. The difference from FIG. 2 is that the UAV also comprises a vertical propeller 393, which may be used for pressing the UAV to a test surface during measurements in order to hold its contact on a test object. In this figure, the propeller does not contain a rod as the rod 37, but this propeller might be also assembled with such a manually or electronically angle-controllable rod, so that the angle may be correspondingly changed to that of the rod 37.

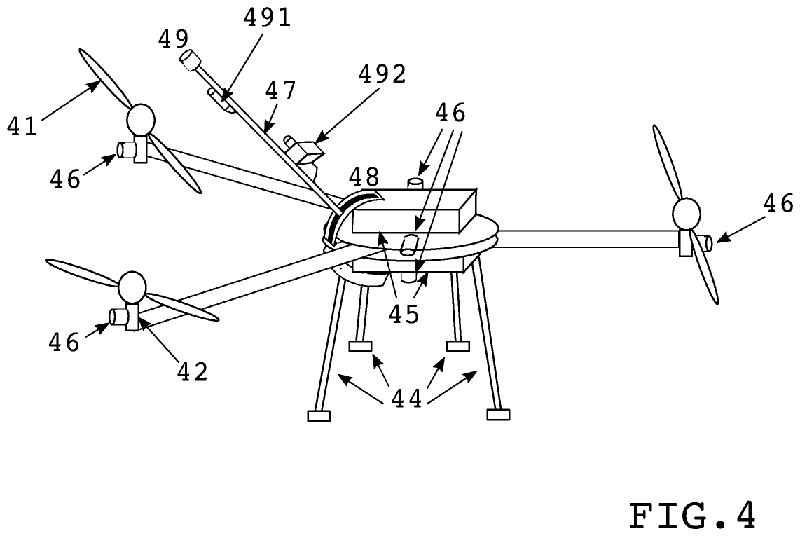

FIG. 4 shows also a conceptual embodiment of a UAV. The difference from FIG. 2 is that the UAV is a tri-copter. On the side of the rod 47, it has two propellers and two distance sensors.

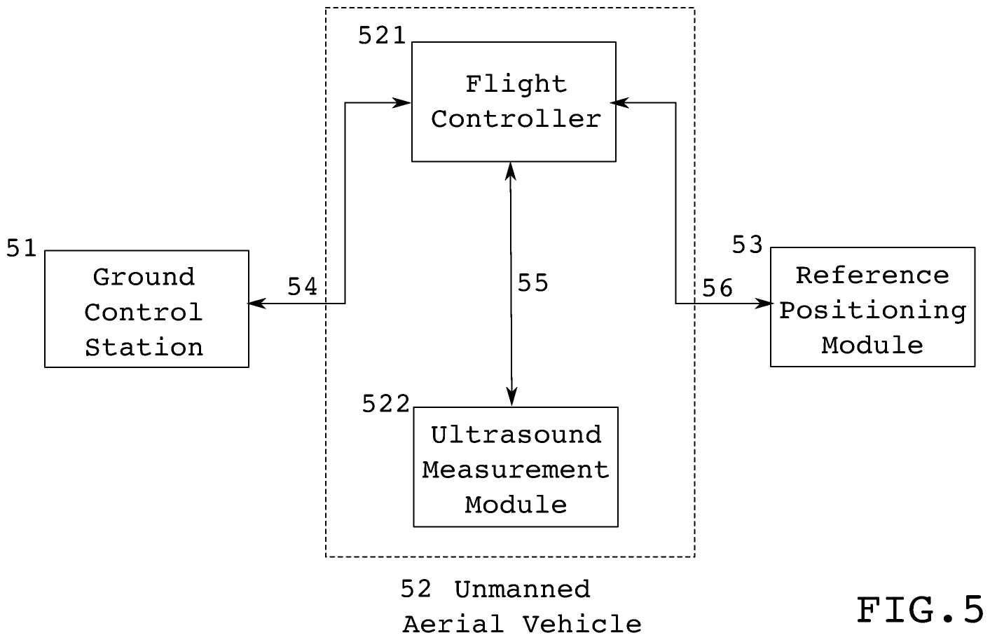

FIG. 5 shows a system block diagram. As depicted, the communication between the GCS 51 and the flight controller 521 in the UAV 52 is bidirectional over the channel 54. That is, the GCS 51 can transmit a trigger signal for flight or measurement as well as a test plan, while it can receive the flight state and the measurement outputs such as ultrasound echo signals or a stress map. A flight trigger from the GCS 51 is for the flight controller 521 to execute a halted autopilot flight command. Similarly, a measurement trigger is to execute a halted ultrasound measurement control command. The communication between the flight controller 521 and the ultrasound measurement module 522 is also bidirectional. Over the channel 55, the flight controller 521 transmits a control signal to the module 522 so that the module can carry out a measurement, when it executes the command on its own or receives a measurement trigger from the GCS 51. On the other hand, when an ultrasound measurement is complete, the ultrasound measurement module 522 responses back to the flight controller 521 for its completion. When this completion gets known to the GCS 51 as part of the flight state, the GCS 51 takes the next action, that is, a continuation of the measurement or a flight to the next hold point. For the former case, the GCS 51 again sends a measurement trigger, while it does a flight trigger for the latter case. The choice depends on a test plan. Note that, the above described involvement of the GCS 51 for measurements is for a collaborative NDT operation among a plurality of UAVs. When a single UAV uses its transducers as both the transmitters and the receivers and carries out measurements alone, these triggers from the GCS 51 are not necessary. Regarding the reference positioning module 53, it sends GPS correction data to the UAV 52 for an outdoor case over the channel 56, whereas it sends a positioning signal for the UAV 52 for an indoor case.

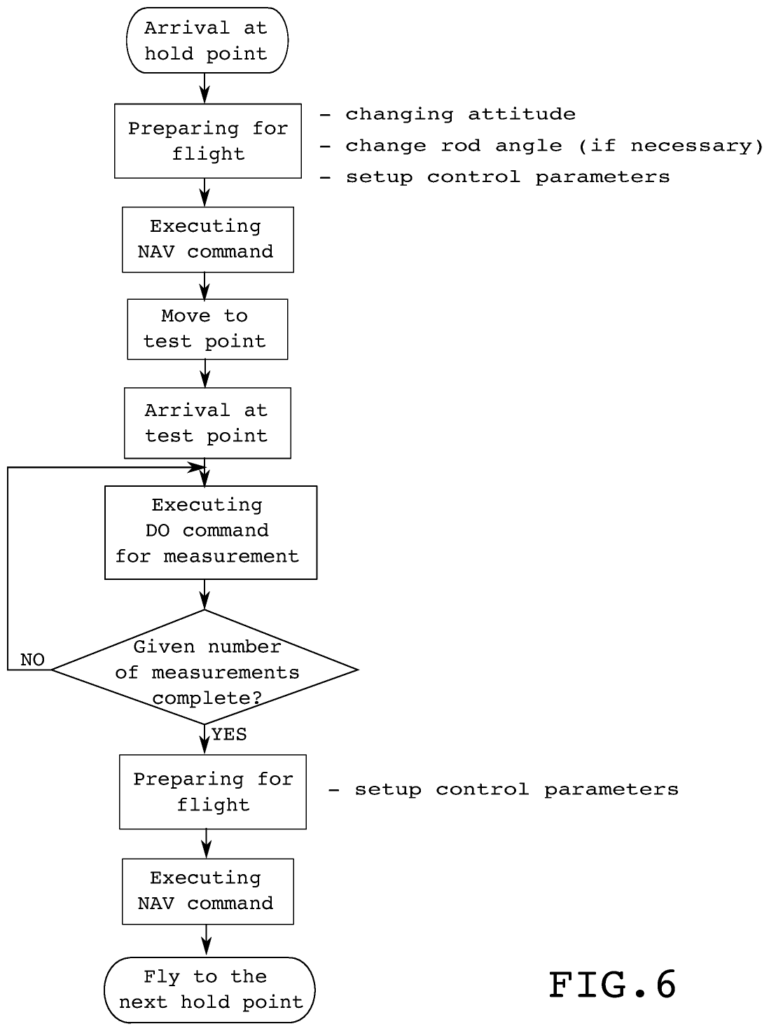

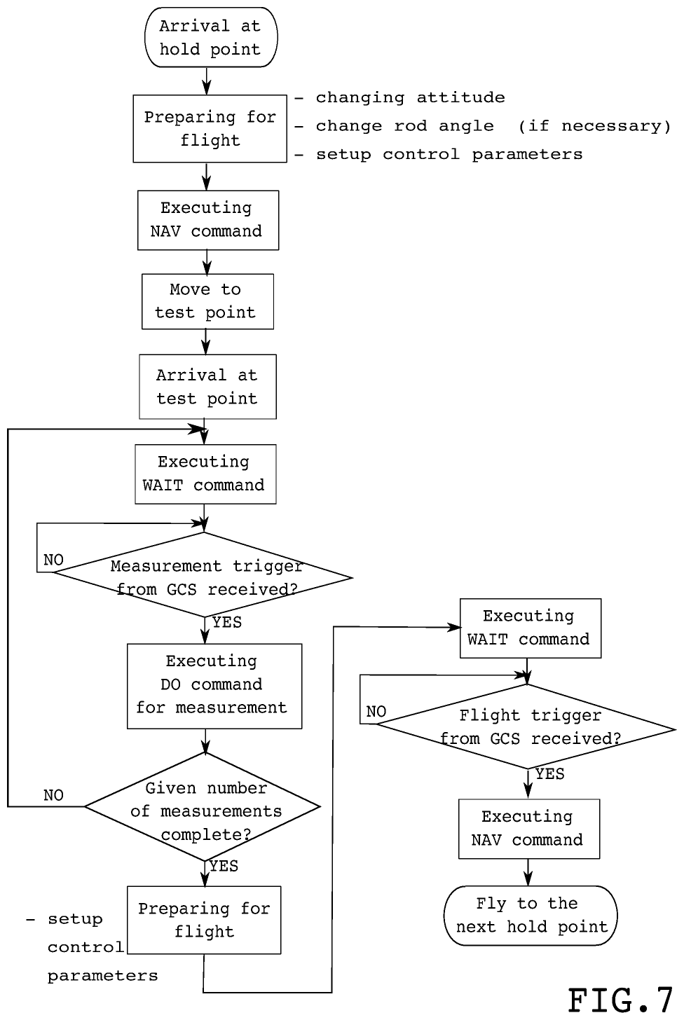

FIGS. 6 and 7 show a process flow diagram of the flight control algorithm for a UAV to contact or nearly contact a test surface on a given test point. FIG. 6 shows a diagram for a UAV to carry out a flight to a test point and a single or a plurality of ultrasound measurements on the point individually. For this case, a UAV flies from a hold point to contact or nearly contact a test point and subsequently performs the number of measurements given by a test plan. After the completion of the measurements, a UAV immediately flies to the next hold point. Here, each flight and measurement are carried out by executing NAV and DO command, respectively. Moreover, before executing a NAV command for flying to a test point, as a preparation, a UAV changes its attitude and rod angle, sets up its control parameters for its flight controller according to the test plan. Also, before a flight to the next hold point, a UAV sets up its control parameters again for the flight. FIG. 7 shows a diagram for a UAV to perform its flight and measurements collaboratively with other UAVs. The differences from FIG. 6 are executions of a WAIT command after its arrival and measurement to do its respective measurement and flight to the next hold point synchronously with other UAVs. These synchronizations are done by a measurement trigger and a flight trigger from a GCS. Note here that, setting up control parameters could be omitted for some realizations.

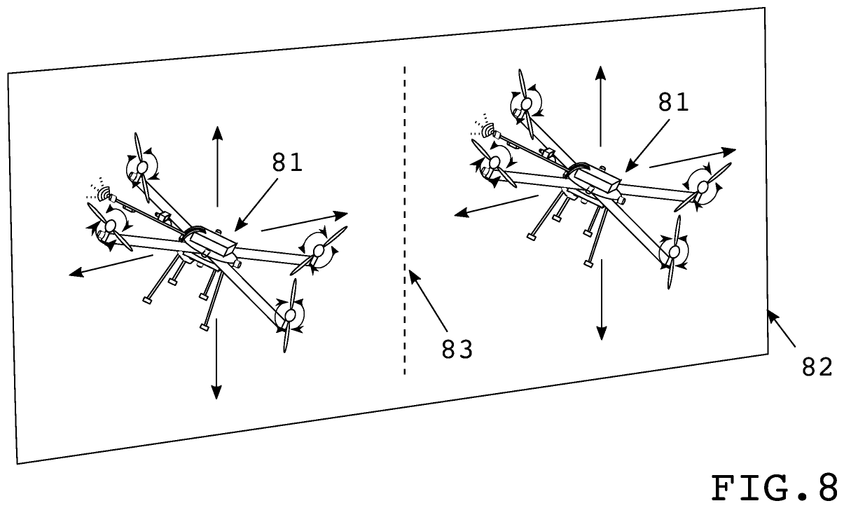

FIG. 8 shows a plurality of UAVs 81 together to perform an NDT on a test surface 82. The dotted line 83 indicates a section line to separate the surface 82, and this separation may be actually done by assigning a different set of test points to a test plan for each UAV.

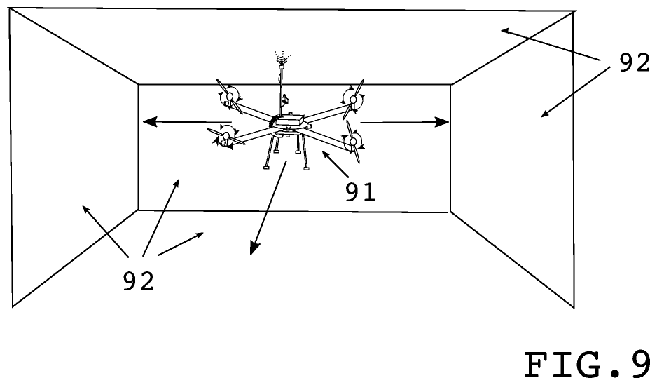

FIG. 9 shows the UAV 91 to test the ceiling 92 inside a test object.

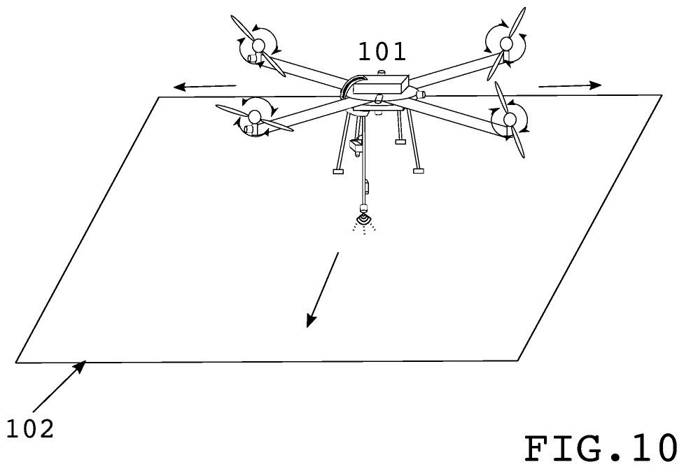

FIG. 10 shows the UAV 101 to test the ground or the floor 102 of a test object or a test area.

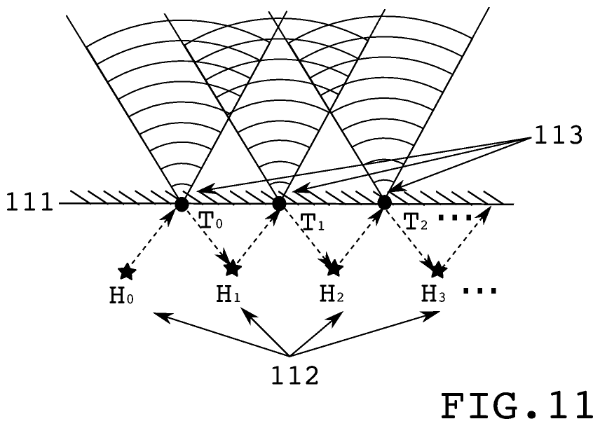

FIG. 11 shows a triangular wave-formed flight path of a UAV. A UAV repeats the followings: first holds itself at a hold point 112 Hᵢ and then flies to a test point 113 Tᵢ for i=0, 1, 2, . . . , in order to test the surface 111. Note that, all these points are positions of ultrasound transducers of a UAV, but not positions of the point of UAV's body frame. Also, the test points Tₛ are slightly above the surface 111 for a near contact, when the UAV uses EMAT.

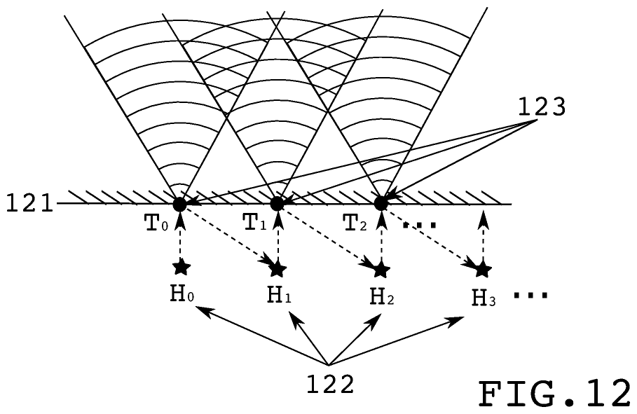

FIG. 12 also shows another flight path of a UAV with a sawtooth pattern.

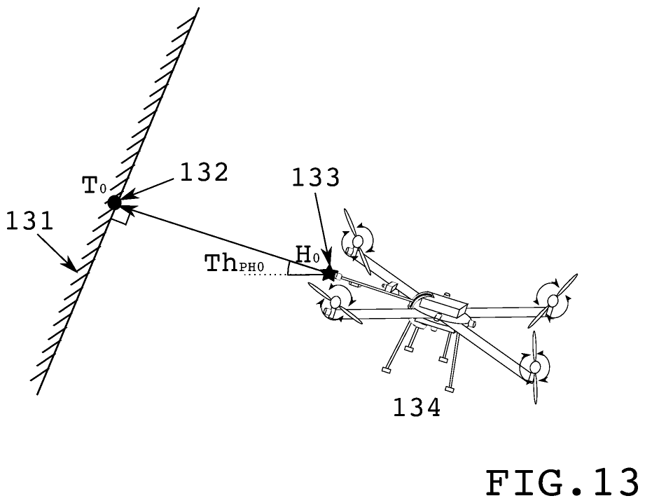

FIG. 13 shows the UAV 134 to have a pitch angle Th_{PHO} at the hold point 133 in order to make itself ready to test the point 132 on the surface 131.

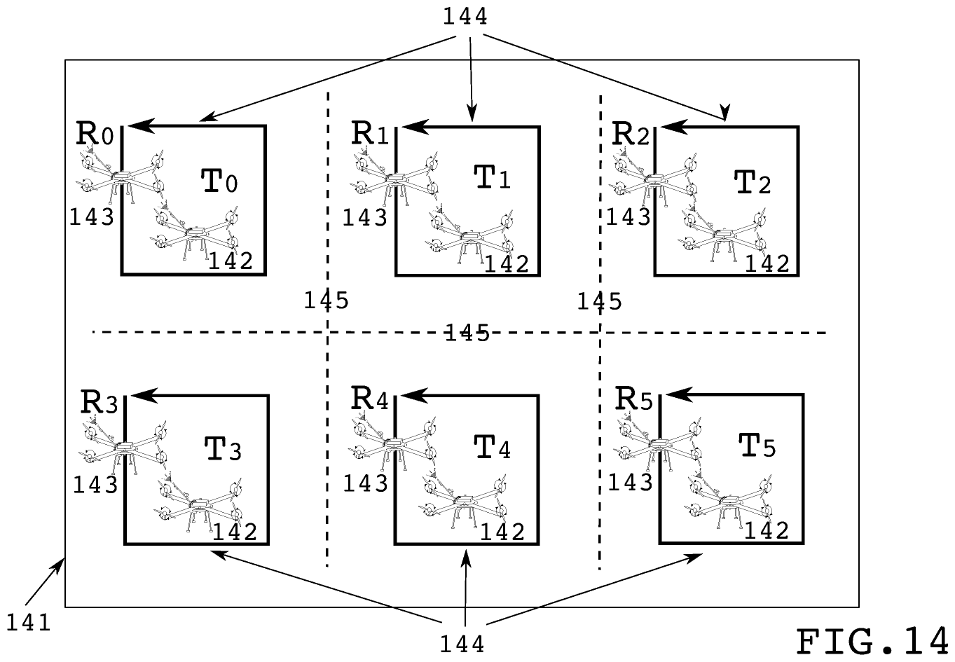

FIG. 14 shows UAVs 142 and 143 measuring stress or stress change sensed over the test surface 141. UAVs 142 located at the transmission points Tᵢ for i=0, 1, 2, . . . transmit ultrasound pulse signals to the surface 141. UAVs 143 in the flight path 144, Rᵢ for i=0, 1, 2, . . . , receive ultrasound echo signals and they transmit them or a created stress map to a GCS. Note that, in this figure, for each measurement, each of UAV 142 maintains a contact or a near contact with the surface 141 at the points Tᵢ, but each of UAV 143 flies along the flight path 144 during the test. Its flight movement may be, for example, one of those depicted in FIG. 11 or 12. Moreover, each UAV may change its role either as a transmitter or a receiver, and it depends on a used test plan. Test area for each pair of transmission and reception UAVs is bounded by the section line 145.

1. A system to automate a non-destructive test for stress or stress change developed within an object, comprises:
ground control station;
wherein the station comprises the following properties:
1. the station transmits a test plan, including a single or a plurality of autopilot flight control commands, to a single or a plurality of unmanned aerial vehicles;
2. the station receives the flight state of a single or a plurality of unmanned aerial vehicles;
3. the station receives and stores ultrasound echo signals or a stress map from a single or a plurality of unmanned aerial vehicles;
4. the station retrieves ultrasound echo signals acquired at different time points from a storage and computes stress or stress change from the temporal ultrasound velocity changes with the signals for creating a stress map;
a single or a plurality of unmanned aerial vehicles;
wherein the vehicle comprises the following properties:
1. the vehicle comprises a single or a plurality of ultrasound transducers for a non-destructive test;
2. the vehicle flies autonomously to a hold point located near above a surface of a test object;
3. the vehicle comprises a single or a plurality of distance sensors to measure distances of ultrasound transducers of the vehicle to an object, and the sensors are used for a vehicle to autonomously move and contact or nearly contact the object;
4. the vehicle carries out a single or a plurality of ultrasound measurements while contacting or nearly contacting a test object to acquire a single or a plurality of ultrasound echo signals;
5. the vehicle stores the acquired ultrasound echo signals locally or transmits them to the ground control station;
a single or a plurality of reference positioning modules;
wherein the modules transmit signals to the vehicles, so that the vehicles, as the receivers, correct or calculate their positions with the signals.

2. The system of claim 1,
wherein the ground control station further comprises the following properties:
1. the station transmits a flight trigger to a single or a plurality of unmanned aerial vehicles, so that each of the vehicles move to a hold point synchronously;
2. the station transmits a measurement trigger to a single or a plurality of unmanned aerial vehicles, so that each of the vehicles carry out an ultrasound measurement synchronously.

3. The system of claim 1,
wherein stress or stress change is computed by using the coda wave interferometry (CWI) method.

4. The system of claim 1,
wherein stress or stress change is computed by using the time-of-flight (TOF) method.

5. The system of claim 1,
wherein an unmanned aerial vehicle retrieves ultrasound echo signals acquired at different time points from a storage and computes stress or stress change from temporal ultrasound velocity changes with them for creating a stress map;
wherein stress or stress change is computed by the coda wave interferometry (CWI) method or the time-of-flight (TOF) method;
wherein the obtained stress map is transmitted to the ground control station;

6. The system of claim 1,
wherein the vehicle further comprises a manually or electronically angle-controllable rod holding the ultrasound transducers;
wherein the angle is changeable from −90 degrees to +90 degrees, and they indicate a direction towards the bottom of the vehicle and its upright direction, respectively;
wherein a damper such as springs is installed between the transducers and the head of the rod.

7. The system of claim 1,
wherein the vehicle further comprises a thermometer;
wherein, with this temperature measurement, ultrasound velocity variation due to a temperature change is compensated.

8. The system of claim 1,
wherein the vehicle further comprises a parachute.

9. The system of claim 1,
wherein the vehicle further comprises a propeller vertically installed to its frame on the opposite side of the rod, in order to hold its contact position on a test object.

10. The system of claim 1,
wherein a reference positioning module is an RTK base station.

11. The system of claim 1,
wherein a reference positioning module is an ultrasound stationary beacon.
